(19) United States
(12) Patent Application Publication
(10) Pub. No.: US 2026/0252241 A1
(43) Pub. Date: Aug. 27, 2026

(54) STORING DATA IN A DATA STORAGE DEVICE BASED ON THERMAL PROPERTIES

(71) Applicant: Sandisk Technologies, Inc., Milpitas, CA (US)

(72) Inventors: Stephen Gold, Fort Collins, CO (US); Steven Sprouse, San Jose, CA (US); Liam Parker, Edinburgh (GB); Avichay Haim Hodes, Kfar Bin Nun (IL)

(21) Appl. No.: 19/061,470

(22) Filed: Feb. 24, 2025

(51) Int. Cl. G06F 3/06

(52) U.S. Cl. CPC G06F 3/0619; G06F 3/0634; G06F 3/0653; G06F 3/0679

(57) ABSTRACT

A data storage device includes a memory die grouping system that groups or associates memory dies of the data storage device based on a determined characteristic, such as a temperature. When the memory dies have been grouped, data stripes are formed or are otherwise associated exclusively with the memory dies in the same group. The memory die grouping system also determines an access frequency of data that is stored by the data storage device. Based on the access frequency, the memory die grouping system determines in which group of memory dies the data will be stored. The memory die grouping system also selectively powers down one or more memory dies based on the determined characteristic and/or based on the grouping of the memory dies.

### BACKGROUND

Data retention is an ability of a data storage device to retain stored data and ensure the data is reliable. One factor that affects data retention is a temperature of the memory dies in the data storage device. For example, data that is stored in memory dies having a higher temperature degrades faster when compared with data stored in memory dies having a lower temperature. As such, data stored in the memory dies with the higher temperature needs to be refreshed more frequently when compared with the data stored in memory dies having the lower temperature.

Typically, a data storage device includes a number of different memory dies. However, due to the layout of the memory dies within the data storage device, some memory dies inherently have a higher temperature when compared with other memory dies in the data storage device. In some cases, data extends across memory dies and each of the memory dies may have different temperatures. For example, in a redundant array of independent devices (RAID) configuration, a data stripe may include higher temperature memory dies and lower temperature memory dies.

However, current data refresh operations are driven by the higher temperature memory dies. As a result, data that is stored in the lower temperature memory dies that do not require the same refresh frequency as data stored in the higher temperature memory dies, may be refreshed unnecessarily. Each refresh operation consumes time and resources and may ultimately reduce the durability, reliability and lifetime of the data storage device.

Accordingly, it would be beneficial to account for thermal properties of memory dies in a data storage device when storing data in the data storage device.

### SUMMARY

The present disclosure describes a data storage device, such as a NAND data storage device, that includes a memory die grouping system. In an example, the memory die grouping system groups or associates memory dies in the data storage device based, at least in part, on a determined characteristic of each of the memory dies. In one example, the characteristic is a temperature or thermal property. When the memory dies have been grouped, and when data is received (e.g., from a host device, as part of a garbage collection operation and/or during a data relocation/refresh operation), data stripes are formed or are otherwise associated with the memory dies in the same group. For example, a first data stripe is formed or is otherwise associated with memory dies having a highest temperature and a second data stripe is formed or is otherwise associated with memory dies having a lowest (or a lower) temperature.

The memory die grouping system also determines an access frequency of data that is stored by, or will be stored by, the data storage device. Based on the access frequency, the memory die grouping system identifies or determines which group of memory dies the data will be stored in or otherwise be associated with. The memory die grouping system also selectively powers down one or more memory dies based, at least in part, on the determined characteristic and/or grouping of the memory dies.

Accordingly, examples of the present disclosure describe a method that includes identifying at least one characteristic of a plurality of memory dies of a data storage device. A first subset of the plurality of memory dies is grouped into a first group based, at least in part, on the first subset of the plurality of memory dies having a first characteristic. Additionally, a second subset of the plurality of memory dies are grouped into a second group based, at least in part, on the second subset of the plurality of memory dies having a second characteristic that is different from the first characteristic. A first data stripe is generated exclusively from the first group of memory dies and a second data stripe is generated exclusively from the second group of memory dies.

The present disclosure also describes a data storage device that includes a first plurality of memory dies associated with a first group and a second plurality of memory dies associated with a second group. In an example, the first plurality of memory dies are associated with the first group based, at least in part, on a first characteristic associated with each memory die of the first plurality of memory dies. Likewise, the second plurality of memory dies are associated with the second group based, at least in part, on a second characteristic associated with each memory die of the second plurality of memory dies. In an example, a first plurality of stripes are associated with the first group and a second plurality of stripes are associated with the second group.

Other examples describe a data storage device that includes means for identifying at least one characteristic of a plurality of memory dies of the data storage device. The data storage device also includes means for grouping a first subset of the plurality of memory dies into a first group based, at least in part, on the first subset of the plurality of memory dies having a first characteristic and means grouping a second subset of the plurality of memory dies into a second group based, at least in part, on the second subset of the plurality of memory dies having a second characteristic that is different from the first characteristic. In an example, the data storage device also includes means for generating a first stripe exclusively from the first group of memory dies and means for generating a second stripe exclusively from the second group of memory dies.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory die includes a number of memory blocks according to an example.

FIG. 2B illustrates how a memory block includes one or more pages according to an example.

FIG. 3A illustrates a data storage device having memory dies that are grouped based, at least in part, on a characteristic according to an example.

FIG. 3B illustrates a side view of the data storage device of FIG. 3A according to an example.

FIG. 4 illustrates a method for grouping memory dies of a data storage device based, at least in part, on a determined characteristic according to an example.

FIG. 5 illustrates a method for storing data in a particular memory die or in a particular group of memory dies based, at least in part, on a determined access frequency according to an example.

FIG. 6 illustrates a method for selectively powering down a group of memory dies according to an example.

FIG. 7 is a perspective view of a storage device that includes three-dimensional (3D) stacked non-volatile memory according to an example.

FIG. 8 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

A data storage device typically includes a number of different memory dies. Depending on the layout and/or configuration of the memory dies, some memory dies may have, or are otherwise associated with, different temperatures or thermal properties. For example, memory dies that are located proximate to or nearest a controller or other integrated circuit of the data storage device may have a higher temperature when compared with memory dies that are located farther away from the controller. In some examples, the temperature difference between the memory dies may be ten degrees Celsius (C) or more.

As previously discussed, data retention of the data storage device is affected by the temperature of the memory dies. For example, data stored in memory dies having a higher temperature degrades faster when compared with data stored in memory dies having a lower temperature. As a result, data stored in the memory dies with the higher temperature needs to be refreshed more frequently when compared with the data stored in memory dies having the lower temperature.

However, in some data storage device configurations and/or implementations, data extends across a number of different memory dies and each of the memory dies may have different temperatures. For example, in a redundant array of independent devices (RAID) configuration, a data stripe may include higher temperature memory dies and lower temperature memory dies. Because current data refresh operations are driven by the higher temperature memory dies, data that is stored in the lower temperature memory dies is refreshed with the same frequency as data stored in higher temperature memory dies—even if the data does not need to be refreshed.

To address the above, the present disclosure describes a data storage device having a memory die grouping system. In an example, the memory die grouping system groups or associates memory dies in the data storage device based, at least in part, on a determined characteristic. In an example, the characteristic is a temperature of the memory die. In another example, the characteristic is a placement of the memory die on a printed circuit board (PCB) or a substrate of the data storage device. In yet another example, the characteristic is a proximity to a controller or other integrated circuit of the data storage device and/or a proximity to a vent or airflow mechanism of the data storage device.

When the memory dies have been grouped and/or when data is received, data stripes are formed or are otherwise associated with the memory dies in the same group. For example, a first data stripe is formed or is otherwise exclusively associated with memory dies in a first group (e.g., memory dies having a highest temperature). Likewise, a second data stripe is formed or is otherwise exclusively associated with memory dies in a second group (e.g., memory dies having a lowest temperature).

The memory die grouping system also determines an access frequency of data that is stored by, or will be stored by, the data storage device. Based on the determined access frequency, the memory die grouping system identifies or determines which group of memory dies the data will be stored in or otherwise associated with. For example, data that is accessed more frequently when compared with other data is stored in memory dies and/or data stripes having the highest temperature. Because the frequently accessed data is more likely to be accessed and/or subsequently rewritten during “normal” operation (e.g., when compared with data that is accessed less frequently), this will reduce the number of refresh operations that will be performed on this data.

Likewise, data that is accessed less frequently is stored on “colder” temperature memory dies. Because this data is accessed less frequently and is stored on “colder” temperature memory dies, the data is retained longer (e.g., due in part to the lower temperature) which also reduces the number of refresh operations that will be performed on the less frequently accessed data.

Accordingly, many technical benefits may be realized including, but not limited to, reducing the impact of data refresh operations, improving the performance of the data storage device and improving the endurance and/or lifetime of the data storage device.

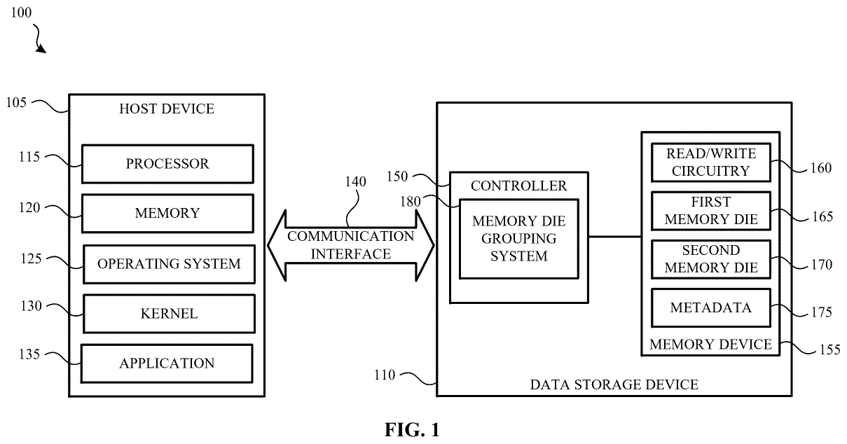

These benefits, along with other examples, will be shown and described in greater detail with respect to FIG. 1-FIG. 8.

FIG. 1 is a block diagram of a system 100 that includes a host device 105 and a data storage device 110 according to an example. In an example, the host device 105 includes a processor 115 and a memory 120 (e.g., main memory). The memory 120 may include or otherwise be associated with an operating system 125, a kernel 130 and/or an application 135.

The processor 115 executes various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data. The data that is used, or executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 may create a virtual address space for the application 135 and/or other processes executed by the processor 115. The virtual address space may map to locations in the memory 120. The operating system 125 may also include or otherwise be associated with a kernel 130. The kernel 130 may include instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes a controller 150 and a memory device 155. In an example, the controller 150 is communicatively coupled to the memory device 155. In an example, the memory device 155 includes one or more memory dies (e.g., first memory die 165 and second memory die 170). Although memory dies are specifically mentioned, the memory device 155 may include any non-volatile memory device, storage device, storage elements or storage medium including NAND flash memory cells and/or NOR flash memory cells.

The memory cells can take the form of solid-state (e.g., flash) memory cells and can be one-time programmable, few-times programmable, or many-times programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, the data storage device 110 is attached to or embedded within the host device 105. In another example, the data storage device 110 is implemented as an external device or a portable device that can be communicatively or selectively coupled to the host device 105.

In yet another example, the data storage device 110 is a component (e.g., a solid-state drive (SSD)) of a network accessible data storage system, a network-attached storage system, a cloud data storage system, or the like.

As indicated above, the memory device 155 of the data storage device 110 includes a first memory die 165 and a second memory die 170. Although two memory dies are shown, the memory device 155 may include any number of memory dies (e.g., one memory die, two memory dies, eight memory dies, or another number of memory dies). In an example, and as will be described in greater detail herein, each memory die may be associated with or have a characteristic. Additionally, the memory dies are grouped based, at least in part, on the characteristic. In an example, the characteristic is a temperature or a thermal property. For example, the first memory die 165 has a first temperature and the second memory die 170 has a second temperature. The temperature may be based, at least in part, on a proximity of the memory dies to the controller 150. Although a temperature is mentioned, the grouping of memory dies may be based on other characteristics.

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

In an example, one or more of the first memory die 165 and the second memory die 170 include one or more planes and each plane may have one or more memory blocks. In an example, each memory block includes one or more memory cells. A block of memory cells is the smallest number of memory cells that are physically erasable together. In an example and for increased parallelism, each of the blocks may be operated or organized in larger blocks or metablocks. For example, one block from different planes of memory cells may be logically linked together to form a metablock.

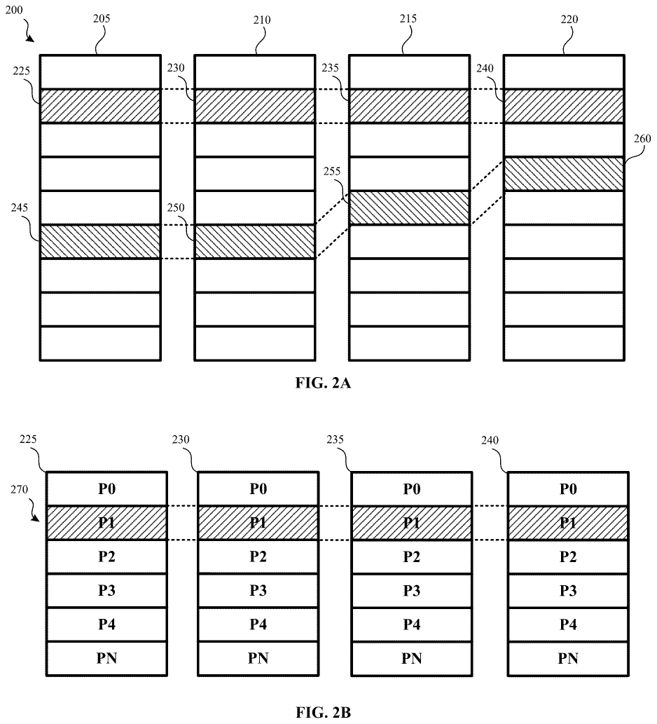

For example and referring to FIG. 2A, a memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die, are provided on two different memory dies (e.g., two planes on each memory die) or are provided on four separate memory dies. Although four planes are shown and described, the memory device 200 may have any number of planes and/or memory dies.

In an example, the planes are divided into memory blocks consisting memory cells. As shown in FIG. 2A, the rectangles represent each memory block, such as memory block 225, memory block 230, memory block 235 and memory block 240. There may be dozens or hundreds of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In addition, various memory blocks may be logically linked or grouped together (e.g., using a table in or otherwise accessible by the controller 150) to form a metablock. A metablock may be written to, read from and/or erased as a single unit. For example, memory block 225, memory block 230, memory block 235 and memory block 240 may form a first metablock while memory block 245, memory block 250, memory block 255 and memory block 260 may form a second metablock. The memory blocks used to form a metablock need not be restricted to the same relative locations within their respective planes.

In an example, each memory block may be divided, for operational purposes, into pages of memory cells, such as illustrated in FIG. 2B. For example, the memory cells of memory block 225, memory block 230, memory block 235 and memory block 240 are divided into N different pages (shown as PO-PN). Although a specific number of pages are shown in FIG. 2B, a memory block may have any number of pages of memory cells within each memory block.

In an example, a page is a unit of data programming within the memory block. Each page includes the minimum amount of data that can be programmed at one time. The minimum unit of data that can be read at one time may be less than a page. A metapage 270 is illustrated in FIG. 2B as being formed of one physical page from memory block 225, memory block 230, memory block 235 and memory block 240. In the example shown, the metapage 270 includes page P1 in each of the four memory blocks. However, the pages of the metapage 270 need not have the same relative position within each of the memory blocks. A metapage 270 may be the maximum unit of programming within a memory block.

The memory blocks disclosed in FIG. 2A-FIG. 2B are referred to herein as physical memory blocks because they relate to groups of physical memory cells. As used herein, a logical memory block is a virtual unit of address space defined to have the same size as a physical memory block. Each logical memory block includes a range of logical memory block addresses (LBAs) that are associated with data received from a host. The LBAs are then mapped to one or more physical memory blocks in the data storage device 110 where the data is physically stored.

As indicated above, each memory block may include any number of memory cells. The design, size, and organization of a memory block may depend on the architecture, design, and application desired for each memory die. In an example, the memory block includes a contiguous set of memory cells that share a plurality of wordlines and bit lines. A wordline may function as a single-level-cell (SLC) wordline, a multi-level-cell (MLC) wordline, a tri-level-cell (TLC) wordline, a quad-level cell (QLC) wordline, a penta-level cell (PLC) wordline and so on. Additionally, each memory cell may be programmable to a state (e.g., a threshold voltage in a flash configuration or a resistive state in a resistive memory configuration) that indicates one or more values.

Referring back to FIG. 1 and as previously described, the data storage device 110 also includes a controller 150. Although a single controller 150 is shown, the data storage device 110 can include multiple controllers. In such an example, a first controller executes a first number and/or type of commands while a second controller executes a second number and/or type of commands. The controllers may operate in parallel and/or independently.

The controller 150 is communicatively coupled to the memory device 155 via a bus, an interface or other communication circuitry. In an example, the communication circuitry may include one or more channels to enable the controller 150 to communicate with the first memory die 165 and/or the second memory die 170 of the memory device 155. In another example, the communication circuitry may include multiple distinct channels which enables the controller 150 to communicate with the first memory die 165 independently and/or in parallel with the second memory die 170 of the memory device 155. For example, a first channel may communicatively couple the controller 150 to the first memory die 165 and a second channel may communicatively couple the controller 150 to the second memory die 170. In another example, the first memory die 165 and the second memory die 170 are grouped together (e.g., based on a characteristic of the memory dies) to form a jumbo device. As a result, a single channel may communicatively couple the controller 150 to the group of memory dies.

The controller 150 receives data and/or instructions from the host device 105. The controller 150 also sends data to the host device 105. In examples, the controller 150 sends data to and/or receives data from the host device 105 via the communication interface 140. The controller 150 also sends data and/or commands to, and/or receive data from, the memory device 155.

The controller 150 sends data and a corresponding write command to the memory device 155 to cause the memory device 155 to store data at a specified address (or a memory die) of the memory device 155. In an example, the write command specifies a physical address of a portion of the memory device 155.

In some examples, the data is written to a particular memory die or group of memory dies based, at least in part, on an access frequency of the data. For example, the controller 150 and/or a memory die grouping system 180 associated with the controller 150 may determine, based on determined or identified data access patterns, whether the data that is received will be accessed frequently or infrequently. If the data will be accessed frequently, the data is stored in a memory dies having a first characteristic (e.g., a high temperature). However, if the data will be accessed infrequently, the data is stored in memory dies having a second characteristic (e.g., a low temperature).

The controller 150 also sends data and/or commands associated with one or more background scanning operations, garbage collection operations, and/or wear leveling operations. The controller 150 also sends one or more read commands to the memory device 155. In an example, the read command specifies the physical address of a portion of the memory device 155 at which the data is stored. The controller 150 may also track the number of program/erase (P/E) cycles or other programming operations that have been performed on or by the memory device 155 and/or on or by the memory dies of the memory device 155. This information may also be stored as metadata 175.

The controller 150 also includes, or is otherwise associated with, a memory die grouping system 180. In an example, the memory die grouping system 180 is a packaged functional hardware unit designed for use with other components/systems. In another example, the memory die grouping system 180 is a portion of a program code (e.g., software or firmware) executable by a processor or processing circuitry. In yet another example, the memory die grouping system 180 is a self-contained hardware and/or software component that interfaces with other components and/or systems. Although the memory die grouping system 180 is shown as being part of the controller 150, the memory die grouping system 180 may be separate from the controller 150.

In an example, the memory die grouping system 180 is operable, along with the controller 150, to determine or identify a characteristic of one or more of the first memory die 165 and/or the second memory die 170. Based, at least in part, on the characteristic, the memory die grouping system 180 groups the first memory die 165 and/or the second memory die 170 into groups with memory dies having the same or a similar characteristic.

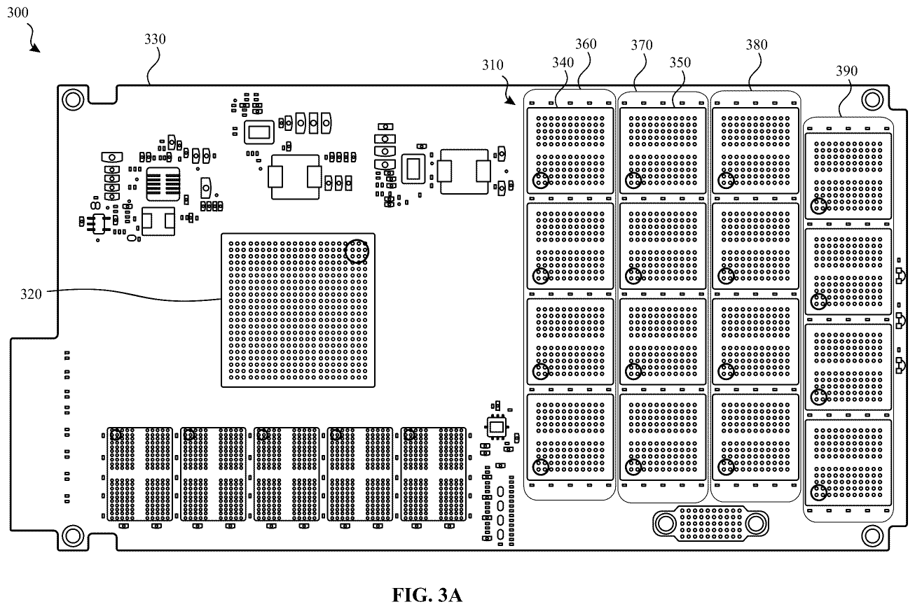

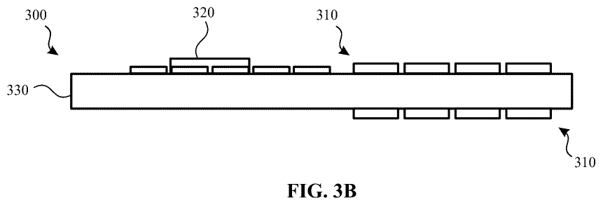

For example and referring to FIG. 3A, FIG. 3A illustrates a data storage device 300 having memory dies 310 that are grouped based, at least in part, on a characteristic according to an example. In an example, the data storage device 300 is similar to the data storage device 110 shown and described with respect to FIG. 1. For example, the data storage device 300 includes a controller 320 and a number of memory dies 310. The controller 320 may be similar to the controller 150 shown and described with respect to FIG. 1. Likewise, the memory dies 310 may be similar to the first memory die 165 and/or the second memory die 170 shown and described with respect to FIG. 1.

In this example, the data storage device 300 includes sixteen memory dies 310 on a first surface of a printed circuit board (PCB) 330 or substrate. The memory dies 310 are arranged in a four-by-four configuration. Although sixteen memory dies 310 are shown and described, the data storage device 300 may have any number of memory dies 310 and the memory dies 310 may be arranged in any configuration.

The data storage device 300 also includes additional memory dies 310 provided on a second surface of the PCB 330. For example and referring to FIG. 3B, FIG. 3B illustrates a side view of the data storage device 300 of FIG. 3A according to an example. As shown in FIG. 3B, the data storage device includes memory dies 310 on the first surface of the PCB 330 and memory dies 310 on the second surface of the PCB 330. In an example, the number of memory dies 310 on the second surface of the PCB 330 match the number of memory dies 310 on the first surface of the PCB 330. Thus, if there are sixteen memory dies 310 on the first surface of the PCB 330, there are also sixteen memory dies 310 on the second surface of the PCB 330.

In an example, the memory dies 310 on the second surface of the PCB 330 are aligned with the memory dies on the first surface of the PCB 330 and may be paired with one another. For example, the memory die 340 on the first surface of the PCB 330 may be paired with a corresponding memory die 310 on the second surface of the PCB 330 in a clamshell configuration and create a first memory die package and are connected to the same channel or bus. Likewise, the memory die 350 on the first surface of the PCB 330 may be paired with a corresponding memory die 310 on the second surface of the PCB 330 to create a second memory die package. Thus, the data storage device 300 may include thirty-two memory die packages.

Referring back to FIG. 3A and as previously discussed, the controller 320, or a memory die grouping system associated with the controller 320, identifies one or more characteristics associated with one or more of the memory dies 310. In an example, the characteristic is a temperature. In another example, the characteristic is a placement of the memory dies 310 on the PCB 330 of the data storage device 300. In yet another example, the characteristic is a proximity of the memory dies 310 to the controller 320 of the data storage device 300. When the characteristic is determined or identified, the memory die grouping system groups or associates memory dies 310 in the data storage device 310 based, at least in part, on the determined characteristic.

In this example, the characteristic is a temperature. Thus, if a particular memory die has or is associated with a first temperature or range of temperatures, the particular memory die is associated with a first group of memory dies. Likewise, if a particular memory die has or is associated with a second temperature or range of temperatures, the particular memory die is associated with a second group of memory dies.

For example, due to its proximity to the controller 320 (which generates heat), the memory die 340 may have a temperature of seventy-six degrees Celsius (C) or more. Although a specific temperature is given, the memory die 340 may have any other temperature. When the temperature of the memory die 340 is determined, the controller 320 associates the memory die 340 with other memory dies having the same or similar temperature and creates a first group of memory dies 360. As shown, the first group of memory dies 360 includes the memory dies 310 that are closest to the controller 320.

In an example, this process is repeated for each of the other memory dies 310 of the data storage device 300. For example, the memory die 350 may have a temperature of seventy five degrees C. As such, controller 320 associates the memory die 350 with other memory dies having the same or similar temperature and creates a second group of memory dies 370. A third group of memory dies 380 and a fourth group of memory dies 390 are created using the same or similar logic.

In addition to grouping the memory dies, the controller 320, or the memory die grouping system associated with the controller 320, causes a number of data stripes to be generated. In an example, the data stripes are generated “on demand” from a pool of available or spare erase memory blocks across one or more memory dies. For example, the memory die grouping system generates or identifies a pool of data stripes when the memory dies have been grouped. In another example, the memory die grouping system generates the data stripes when data is received. However, in some examples, instead of generating data stripes across all of the memory dies 310 (e.g., instead of generating data stripes across memory dies 310 having different temperatures or other characteristics), the data stripes are formed from memory dies that are exclusively in the same group.

For example, a first set of data stripes extends across all of the memory die packages in the first group of memory dies 360. Likewise, a second set of data stripes extends across all of the memory die packages in the second group of memory dies 370, a third set of data stripes extends across all of the memory die packages in the third group of memory dies 380 and a fourth set of data stripes extends across all of the memory die packages in the fourth group of memory dies 390. In an example, the data stripe is a XOR data stripe. Because the data stripes are formed from memory dies having the same characteristic and because data refresh operations are driven by temperature, data associated with each memory die group have the same or a similar refresh frequency.

In an example, the controller 320 may cause data to be written to, or accessed from, or may perform garbage collection operations on, data stripes from each of the different groups of memory dies. These operations may be executed in parallel, substantially in parallel or in series. For example, the controller 320 may cause data to be written to a first data stripe associated with the first group of memory dies 360 at the same time or during a similar time as data is being written to, or accessed from, a data stripe associated with the second group of memory dies 370, the third group of memory dies 380 and/or the fourth group of memory dies 390 (e.g., the times at which operations are being performed on the different data stripes at least partially overlap).

Referring back to FIG. 1, when the memory die groups are formed or are otherwise determined, the memory die grouping system 180 also places data in various memory blocks, subblocks and/or data stripes based, at least in part, on a determined access frequency of the data in combination the determined characteristic. For example, some of the data stored in the data storage device 110 may be accessed frequently (also referred to as “hot” data) while other data stored in the data storage device may be accessed less frequently or infrequently (also referred to as “cold” data).

The memory die grouping system 180 causes the hot data to be stored in higher temperature memory dies and causes the cold data to be stored in lower temperature memory dies. For example, when data is received, the memory die grouping system 180 determines or otherwise identifies (e.g., based on previous data use patterns and/or based on the type of data received) whether the received data will be accessed frequently or infrequently. Since data that is accessed frequently will be rewritten or overwritten, this data is stored on higher temperature memory dies (e.g., the memory dies associated with the first group of memory dies 360 (FIG. 3A)).

Because this data will be rewritten during “normal” operation, the amount of data refresh operations that need to be executed on this data is reduced when compared with current solutions. For example, when data is rewritten, a garbage collection operation will commence, which will naturally reduce the number of the data retention and refresh operations that would normally be executed on the data.

As previously discussed, data that is identified as cold data is stored in lower temperature memory dies such as, for example, the memory dies associated with the fourth group of memory dies 390 (FIG. 3A). In some examples, the memory die grouping system 180 identifies cold data during a garbage collection operation and continues to move data to the different groups of memory dies as the data gets colder.

For example and referring back to FIG. 3A, when data is first received, the memory die grouping system 180 may cause the data to be written in the first group of memory dies 360. However, when a garbage collection operation or a data refresh/relocation operation is performed, the memory die grouping system 180 may move the data to the second group of memory dies 370. During a subsequent garbage collection operation or relocation/refresh operation, the memory die grouping system 180 may determine that the data is colder still. As a result, the memory die grouping system 180 moves the data to the third group of memory dies 380 and ultimately to the fourth group of memory dies 390.

However, the reverse may also be true. If data that is stored in a particular group of memory dies (e.g., the fourth group of memory dies 390) begins to be accessed more frequently (e.g., begins to be identified as hot), the memory die grouping system 180 will cause the data to be stored in another group of memory dies (e.g., the third group of memory dies 380).

In an example and in order to balance the number of program/erase (P/E) cycles across the various groups of memory dies, the memory die grouping system 180 will balance where a percentage of hot data is stored. For example, the memory die grouping system 180 will store a first percentage of hot data in the first group of memory dies 360, a second percentage of hot data in the second group of memory dies 370, a third percentage of hot data in the third group of memory dies 380 and a fourth percentage of hot data in the fourth group of memory dies 390.

Referring back to FIG. 1, the memory die grouping system 180 may also be configured to selectively power down various groups of memory dies. For example, there are two types of data retention—online data retention and offline data retention. Online data retention is shorter when compared to offline data retention due to hotter memory die temperatures. For example, data may be retained for forty hours at a given temperature (e.g., sixty-seven C) when a memory die is online. However, data may be retained for three months at a given temperature (e.g., forty C) when the memory die is offline.

Accordingly, and in order to increase data retention times of data (e.g., cold data), the memory die grouping system 180 selectively powers down memory dies. In an example, the memory dies that are powered down are the memory dies that are farthest away from the controller 150. For example, the memory die grouping system 180 would periodically power down one or more memory dies from the third group of memory dies 380 (FIG. 3A) and/or memory dies from the fourth group of memory dies 390 (FIG. 3A).

In an example, the memory dies would be powered up and/or down based, at least in part, on commands that are received from a host device (e.g., the host device 105 (FIG. 1)) and/or if a relocation operation is to be performed on one or more memory dies within that particular group of memory dies.

In an example, the memory die grouping system may power down one or more memory dies (or groups of memory dies) based on an activity timer. For example, if the memory die grouping system 180 determines that the memory die has not been accessed for over a threshold amount of time (e.g., one second), the memory die is powered down.

Given that the powered down memory die contains cold data, there will not be a lot of operations to this memory die and the memory die will not use a lot of power. As a result, the temperature of the memory die will be lower than normal. This, in addition to being located in the coolest part of the data storage device, will increase the data retention of the data stored in these memory dies when compared with current solutions.

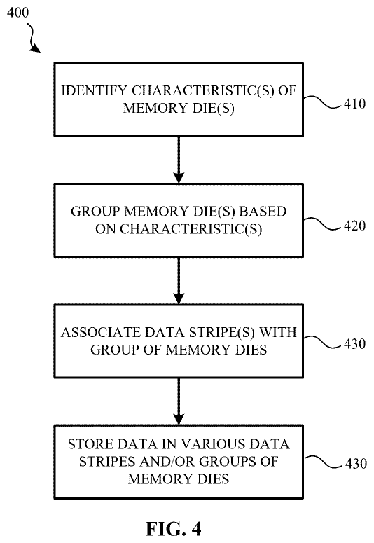

FIG. 4 illustrates a method 400 for grouping memory dies of a data storage device based, at least in part, on a determined characteristic according to an example. In an example, the method 400 is performed by a memory die grouping system of a data storage device, such as the memory die grouping system 180 shown and described with respect to FIG. 1. In addition to grouping memory dies based on the determined characteristic, the memory die grouping system may also generate and/or associate data stripes (e.g., XOR data stripes) with a particular group of memory dies. In an example, particular memory dies are grouped to form different jumbo devices.

The method 400 begins when the memory die grouping system identifies (410) one or more characteristics of one or more memory dies. In an example, the characteristic is a determined temperature of one or more memory dies. In another example, the characteristic is a proximity of the memory die to an integrated circuit or controller of the data storage device. In some examples, the characteristics may be known or otherwise provided to firmware of the data storage device.

When the one or more characteristics have been determined or identified, the memory die grouping system groups (420) memory dies together based on the characteristics. For example, the memory die grouping system groups or associates memory dies having a first temperature or a first range of temperatures into a first group. Likewise, the memory die grouping system groups or associates memory dies having a second temperature or a second range of temperatures into a second group.

When the groups of memory dies have been formed and/or when data is received, the memory die grouping system also forms and/or associates (430) data stripes with each of the groups of memory dies. In an example, the data stripes are formed exclusively from each of the groups of memory dies. For example, a first plurality of data stripes are formed or associated with memory dies from the first group of memory dies (e.g., memory dies that have the same or similar first characteristic). Likewise, a second plurality of data stripes are formed or associated with memory dies from the second group of memory dies (e.g., memory dies that have the same or similar second characteristic (e.g., where the first characteristic and the second characteristic is a temperature).

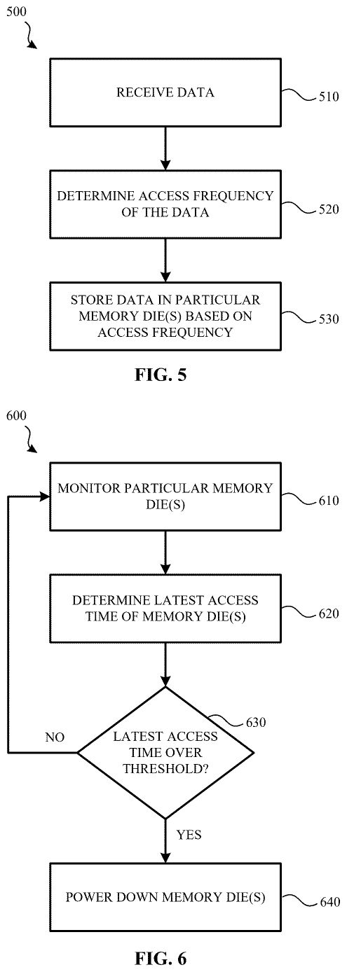

When data is received, the memory die grouping system also stores (440) data in the various data stripes and/or groups of memory dies. In an example, the data is stored in various data stripes and/or memory dies based on a determined access frequency of the data. For example, and referring to FIG. 5, FIG. 5 illustrates a method 500 for storing data in a particular memory die or in a particular group of memory dies based, at least in part, on a determined access frequency according to an example. In an example, the method 500 is performed by a memory die grouping system of a data storage device, such as the memory die grouping system 180 shown and described with respect to FIG. 1. In addition, the method 500 may be performed in combination with the method 400 shown and described with respect to FIG. 4.

As previously discussed, in some examples, memory dies of a data storage device are grouped (or form jumbo devices) based, at least in part, on one or more characteristics (e.g., a temperature or a thermal property of the memory dies). Additionally, various memory blocks of the memory dies in a group or organized or formed into one or more data stripes (e.g., XOR data stripes).

When the memory dies are grouped, data is received (510). In some examples, the data is received from a host device. In other examples, the data that is received is data that will be relocated and/or refreshed as part of a data relocation/data refresh operation and/or a garbage collection operation.

When the data is received, the memory die grouping system determines (520) an access frequency of the data. For example, the memory die grouping system determines whether the received data is “hot” or “cold”. In an example, any suitable operation or set of operations may be used to determine the access frequency of the data.

When the access frequency of the data is determined, the memory die grouping system causes the data to be stored (530) in a particular memory die based, at least in part, on the determined access frequency. In an example, the particular memory die may be a particular group of memory dies, a sub-drive of the particular memory die, various memory blocks of one or more memory dies and/or a XOR stripe.

For example, data that is classified as, or determined to be “hot” (e.g., accessed the most frequently) will be stored in the highest temperature memory dies. In an example, because the data is hot, the data will be overwritten more frequently which may reduce write amplification. Likewise, colder data is relocated (e.g., during one or more garbage collection operations) to other groups of memory dies.

In some examples, the memory dies with higher temperatures and/or the memory dies that store hot data will have more P/E cycles when compared with memory dies that have lower temperatures and/or store cold data. Accordingly, in some examples, the memory die grouping system incorporates a wear leveling scheme. In an example, the wear leveling scheme causes a certain percentage of hot data to be stored in colder memory dies or groups of memory dies so as to balance data retention and/or relocation operations across the various memory dies.

FIG. 6 illustrates a method 600 for selectively powering down a group of memory dies according to an example. In an example, the method 600 is performed by a memory die grouping system of a data storage device, such as the memory die grouping system 180 shown and described with respect to FIG. 1. In addition, the method 600 may be performed in combination with the method 400 shown and described with respect to FIG. 4 and/or the method 500 shown and described with respect to FIG. 5.

The method 600 begins by monitoring (610) one or more memory dies. In an example, the one or more memory dies that are monitored are memory dies that are grouped together based on one or more characteristics and in which the characteristic is below a characteristic threshold. For example, if the characteristic is a temperature, the memory dies that have a temperature below a temperature threshold are monitored. For example and referring to FIG. 3A, memory dies in the third group of memory dies 380 and/or memory dies in the fourth group of memory dies 390 may be monitored because they have lower temperatures when compared with the memory dies in the first group of memory dies 360 and the memory dies in the second group of memory dies 370. In another example, memory dies that store a particular type of data (e.g., cold data) are monitored.

As part of the monitoring process, the memory die grouping system determines (620) a latest access time of the monitored one or more memory dies. For example, the memory die grouping system determines when the one or more memory dies were last accessed. For example, the memory die grouping system determines whether the one or more memory dies have been accessed in the last second, in the last five seconds, etc. Although a specific time period has been mentioned, other time periods may be used.

The memory die grouping system then determines (630) whether the latest access time is over an access time threshold. If the memory die grouping system determines (630) the latest access time is under the access time threshold, the memory die grouping system continues monitoring (610) the particular one or more memory dies and the method 600 is repeated. However, if the memory die grouping system determines (630) the latest access time is over the access time threshold, the memory die grouping system powers down (640) the one or more memory dies. As a result, the data stored in the powered down memory dies will have a longer retention time when compared to data stored in memory dies that are not powered down.

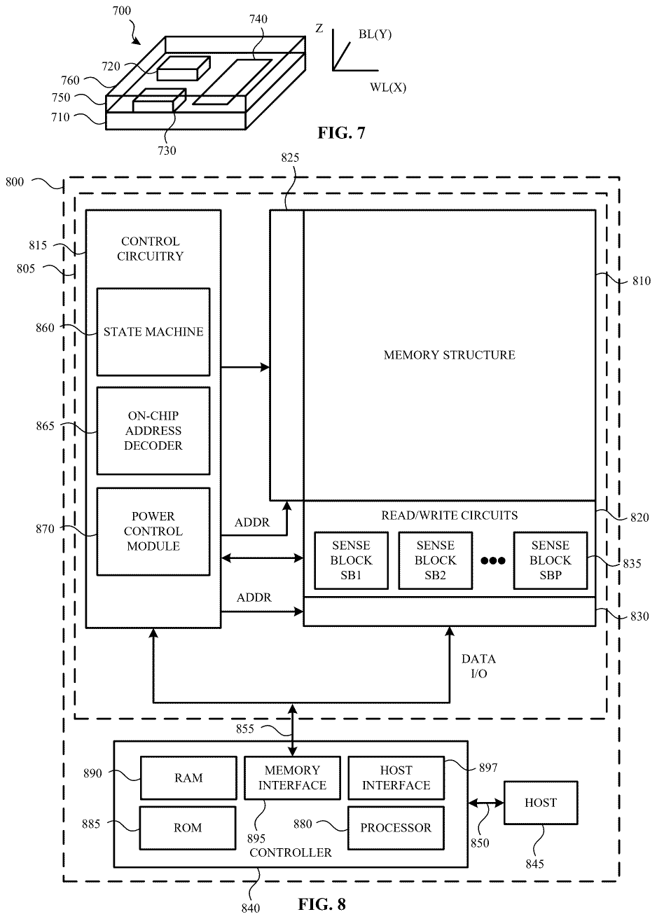

FIG. 7-FIG. 8 describe example storage devices that may be used with or otherwise implement the various features described herein. For example, the storage devices shown and described with respect to FIG. 7-FIG. 8 may include various systems and components that are similar to the systems and components shown and described with respect to FIG. 1. For example, the controller 840 shown and described with respect to FIG. 8 may be similar to the controller 150 of FIG. 1. Likewise, the memory dies 805 may be similar to the first memory die 165 and/or the second memory die 170 of FIG. 1.

FIG. 7 is a perspective view of a storage device 700 that includes three-dimensional (3D) stacked non-volatile memory according to an example. In this example, the storage device 700 includes a substrate 710. Blocks of memory cells are included on or above the substrate 710. The blocks include a first block (BLK0 720) and a second block (BLK1 730). Each block is formed of memory cells (e.g., non-volatile memory elements). The substrate 710 also includes a peripheral area 740 having support circuits that are used by the first block and the second block.

The substrate 710 also carries circuits under the blocks, along with one or more lower metal layers which are patterned in conductive paths to carry signals from the circuits. In an example, the blocks are formed in an intermediate region 750 of the storage device 700. The storage device also includes an upper region 760. The upper region 760 includes one or more upper metal layers that are patterned in conductive paths to carry signals from the circuits. Each block of memory cells includes a stacked area of memory cells. In an example, alternating levels of the stack represent wordlines. While two blocks are depicted, additional blocks may be used and extend in the x-direction and/or the y-direction.

In an example, a length of a plane of the substrate 710 in the x-direction represents a direction in which signal paths for wordlines or control gate lines extend (e.g., a wordline or drain-end select gate (SGD) line direction) and the width of the plane of the substrate 710 in the y-direction represents a direction in which signal paths for bit lines extend (e.g., a bit line direction). The z-direction represents a height of the storage device 700.

FIG. 8 is a functional block diagram of a storage device 800 according to an example. In an example, the storage device 800 is similar to the 3D stacked non-volatile storage device 700 shown and described with respect to FIG. 7. In an example, the components depicted in FIG. 8 are electrical circuits. In an example, the storage device 800 includes one or more memory dies 805. Each memory die 805 includes a three-dimensional memory structure 810 of memory cells (e.g., a 3D array of memory cells), control circuitry 815, and read/write circuits 820. In another example, a two-dimensional array of memory cells may be used. The memory structure 810 is addressable by wordlines using a first decoder 825 (e.g., a row decoder) and by bit lines using a second decoder 830 (e.g., a column decoder). The read/write circuits 820 may also include multiple sense blocks 835 including SB1, SB2, . . . SBp (e.g., sensing circuitry) which allow pages of the memory cells to be read or programmed in parallel. The sense blocks 835 may include bit line drivers.

In an example, a controller 840 is included in the same storage device 800 as the one or more memory dies 805. In another example, the controller 840 is formed on a die that is bonded to a memory die 805, in which case each memory die 805 may have its own controller 840. In yet another example, a controller die controls all of the memory dies 805. Although a single controller 840 is shown, the storage device 800 can include multiple controllers with each controller responsible for different operations described herein.

Commands and data are transferred between a host 845 and the controller 840 using a data bus 850. Additionally, commands and data are transferred between the controller 840 and one or more of the memory dies 805 by way of lines 855. In one example, the memory die 805 includes a set of input and/or output (I/O) pins that connect to lines 855.

The memory structure 810 also includes one or more arrays of memory cells. The memory cells are arranged in a three-dimensional array or a two-dimensional array. The memory structure 810 includes any type of non-volatile memory that is formed on one or more physical levels of arrays of memory cells having an active area disposed above a silicon substrate. The memory structure 810 may be in a non-volatile memory device having circuitry associated with the operation of the memory cells, whether the associated circuitry is above or within the substrate.

The control circuitry 815 works in conjunction with the read/write circuits 820 to perform memory operations (e.g., erase, program, read, and others) on the memory structure 810. The control circuitry 815 may include registers, ROM fuses, and other devices for storing default values such as base voltages and other parameters.

The control circuitry 815 also includes a state machine 860, an on-chip address decoder 865 and a power control module. The state machine 860 provides chip-level control of various memory operations, such as selecting a memory block for programming. The state machine 860 is programmable by software. In another example, the state machine 860 does not use software and is completely implemented in hardware (e.g., electrical circuits).

The on-chip address decoder 865 provides an address interface between addresses used by host 845 and/or the controller 840 to a hardware address used by the first decoder 825 and the second decoder 830. The power control module 870 controls power and voltages that are supplied to the wordlines and bit lines during memory operations. The power control module 870 may include drivers for wordline layers in a 3D configuration, select transistors (e.g., SGS and SGD transistors) and source lines. The power control module 870 may include one or more charge pumps for creating voltages. In an example, the power control module 870 helps ensure wordlines of the grown bad block described herein are programmed at the desired levels.

The control circuitry 815, the state machine 860, the on-chip address decoder 865, the first decoder 825, the second decoder 830, the power control module 870, the sense blocks 835, the read/write circuits 820, and/or the controller 840 may be considered one or more control circuits and/or a managing circuit that perform some or all of the operations described herein.

In an example, the controller 840, is an electrical circuit that may be on-chip or off-chip. Additionally, the controller 840 may include one or more processors 880, ROM 885, RAM 890, memory interface 895, and host interface 897, all of which may be interconnected. In an example, the one or more processors 880 is one example of a control circuit. Other examples can use state machines or other custom circuits designed to perform one or more functions. Devices such as ROM 885 and RAM 890 may include code such as a set of instructions. One or more of the processors 880 may be operable to execute the set of instructions to provide some or all of the functionality described herein.

Alternatively or additionally, one or more of the processors 880 may access code from a memory device in the memory structure 810, such as a reserved area of memory cells connected to one or more wordlines. The memory interface 895, in communication with ROM 885, RAM 890, and one or more of the processors 880, may be an electrical circuit that provides an electrical interface between the controller 840 and the memory die 805. For example, the memory interface 895 may change the format or timing of signals, provide a buffer, isolate from surges, latch I/O, and so forth.

The one or more processors 880 may issue commands to control circuitry 815, or any other component of memory die 805, using the memory interface 895. The host interface 897, in communication with the ROM 885, the RAM 890, and the one or more processors 880, may be an electrical circuit that provides an electrical interface between the controller 840 and the host 845. For example, the host interface 897 may change the format or timing of signals, provide a buffer, isolate from surges, latch I/O, and so on. Commands and data from the host 845 are received by the controller 840 by way of the host interface 897. Data sent to the host 845 may be transmitted using the data bus 850.

Multiple memory elements in the memory structure 810 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

Based on the above, examples of the present disclosure describe a method, comprising: identifying at least one characteristic of a plurality of memory dies of a data storage device; grouping a first subset of the plurality of memory dies into a first group based, at least in part, on the first subset of the plurality of memory dies having a first characteristic; grouping a second subset of the plurality of memory dies into a second group based, at least in part, on the second subset of the plurality of memory dies having a second characteristic that is different from the first characteristic; generating a first data stripe exclusively from the first group of memory dies; and generating a second data stripe exclusively from the second group of memory dies. In an example, at least one the first characteristic and the second characteristic is a temperature. In an example, at least one the first characteristic and the second characteristic is a determined physical location of the plurality of memory dies in the data storage device. In an example, the method also includes determining an access frequency of received data; and storing the received data in either the first group of memory dies or the second group of memory dies based, at least in part, on the determined access frequency. In an example, data associated with the first data stripe is associated with a first access frequency and wherein data associated with the second data stripe is associated with a second access frequency that is different than the first access frequency. In an example, the method also includes powering down the second group of memory dies based, at least in part, on the second access frequency. In an example, the method also includes powering up the second group of memory dies after a period of time; and performing an audit on the data to determine whether to execute a data refresh operation.

Other examples describe a data storage device, comprising: a first plurality of memory dies associated with a first group based, at least in part, on a first characteristic associated with each memory die of the first plurality of memory dies; a second plurality of memory dies associated with a second group based, at least in part, on a second characteristic associated with each memory die of the second plurality of memory dies; a first plurality of stripes associated with the first group; and a second plurality of stripes associated with the second group. In an example, at least one of the first characteristic and the second characteristic is a temperature. In an example, the first characteristic is a first physical location of the first plurality of memory dies and the second characteristic is a second physical location of the second plurality of memory dies. In an example, the data storage device also includes a controller operable to: determine an access frequency of received data; and determine whether to store the data in the first plurality of memory dies or the second plurality of memory dies based, at least in part, on the access frequency. In an example, data associated with the first plurality of stripes is associated with a first access frequency and wherein data associated with the second plurality of stripes is associated with a second access frequency that is different than the first access frequency. In an example, the controller is further operable to power down at least one memory die of the second plurality of memory dies based, at least in part, on the second access frequency. In an example, the controller is further operable to: power up the at least one memory die of the second plurality of memory dies after a period of time; and perform an audit on the data to determine whether to execute a data refresh operation.

Examples also describe a data storage device, comprising: means for identifying at least one characteristic of a plurality of memory dies of the data storage device; means for grouping a first subset of the plurality of memory dies into a first group based, at least in part, on the first subset of the plurality of memory dies having a first characteristic; means grouping a second subset of the plurality of memory dies into a second group based, at least in part, on the second subset of the plurality of memory dies having a second characteristic that is different from the first characteristic; means for generating a first stripe exclusively from the first group of memory dies; and means for generating a second stripe exclusively from the second group of memory dies. In an example, at least one the first characteristic and the second characteristic is a temperature. In an example, at least one the first characteristic and the second characteristic is a determined physical location of the plurality of memory dies in the data storage device. In an example, the data storage device also includes means for determining an access frequency of received data; and means for storing the received data in either the first group of memory dies or the second group of memory dies based, at least in part, on the determined access frequency. In an example, data associated with the first stripe is associated with a first access frequency and wherein data associated with the second stripe is associated with a second access frequency that is different than the first access frequency. In an example, the data storage device also includes means for powering down the second group of memory dies based, at least in part, on the second access frequency.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this disclosure that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

1. A method, comprising:
identifying at least one temperature characteristic of a plurality of memory dies of a data storage device;
grouping a first subset of the plurality of memory dies into a first group based, at least in part, on the first subset of the plurality of memory dies having a first temperature characteristic;
grouping a second subset of the plurality of memory dies into a second group based, at least in part, on the second subset of the plurality of memory dies having a second temperature characteristic that is different from the first temperature characteristic;
generating a first data stripe exclusively from the first group of memory dies; and
generating a second data stripe exclusively from the second group of memory dies.

2. (canceled)

3. The method of claim 1, wherein the first temperature characteristic and the second temperature characteristic are based, at least in part, on physical locations of the plurality of memory dies in the data storage device.

4. The method of claim 1, further comprising:
determining an access frequency of received data; and
storing the received data in either the first group of memory dies or the second group of memory dies based, at least in part, on the determined access frequency.

5. The method of claim 1, wherein data associated with the first data stripe is associated with a first access frequency and wherein data associated with the second data stripe is associated with a second access frequency that is different than the first access frequency.

6. The method of claim 5, further comprising powering down the second group of memory dies based, at least in part, on the second access frequency.

7. The method of claim 6, further comprising:
powering up the second group of memory dies after a period of time; and
performing an audit on the data to determine whether to execute a data refresh operation.

8. A data storage device, comprising:
a first plurality of memory dies associated with a first group based, at least in part, on a first temperature characteristic associated with each memory die of the first plurality of memory dies;
a second plurality of memory dies associated with a second group based, at least in part, on a second temperature characteristic associated with each memory die of the second plurality of memory dies;
a first plurality of stripes associated with the first group; and
a second plurality of stripes associated with the second group.

9. (canceled)

10. The data storage device of claim 8, wherein the first temperature characteristic and the second temperature characteristic are based, at least in part on physical locations of the first plurality of memory dies and the second plurality of memory dies.

11. The data storage device of claim 8, further comprising a controller operable to:
determine an access frequency of received data; and
determine whether to store the data in the first plurality of memory dies or the second plurality of memory dies based, at least in part, on the access frequency.

12. The data storage device of claim 8, wherein data associated with the first plurality of stripes is associated with a first access frequency and wherein data associated with the second plurality of stripes is associated with a second access frequency that is different than the first access frequency.

13. The data storage device of claim 12, wherein the controller is further operable to power down at least one memory die of the second plurality of memory dies based, at least in part, on the second access frequency.

14. The data storage device of claim 13, wherein the controller is further operable to:
power up the at least one memory die of the second plurality of memory dies after a period of time; and
perform an audit on the data to determine whether to execute a data refresh operation.

15. A data storage device, comprising:
means for identifying at least one temperature characteristic of a plurality of memory dies of the data storage device;
means for grouping a first subset of the plurality of memory dies into a first group based, at least in part, on the first subset of the plurality of memory dies having a first temperature characteristic;
means for grouping a second subset of the plurality of memory dies into a second group based, at least in part, on the second subset of the plurality of memory dies having a second temperature characteristic that is different from the first temperature characteristic;
means for generating a first stripe exclusively from the first group of memory dies; and
means for generating a second stripe exclusively from the second group of memory dies.

16. (canceled)

17. The data storage device of claim 15, wherein the first temperature characteristic and the second temperature characteristic are based, at least in part, on physical locations of the plurality of memory dies in the data storage device.

18. The data storage device of claim 15, further comprising:
means for determining an access frequency of received data; and
means for storing the received data in either the first group of memory dies or the second group of memory dies based, at least in part, on the determined access frequency.

19. The data storage device of claim 15, wherein data associated with the first stripe is associated with a first access frequency and wherein data associated with the second stripe is associated with a second access frequency that is different than the first access frequency.

20. The data storage device of claim 19, further comprising means for powering down the second group of memory dies based, at least in part, on the second access frequency.

21. The method of claim 1, wherein the first temperature characteristic and the second temperature characteristic are based on a proximity of the plurality of memory dies to a controller of the data storage device.

22. The data storage device of claim 8, wherein data stripes formed from the first group and data stripes formed from the second group each have a common data refresh frequency.

23. The data storage device of claim 15, wherein the first temperature characteristic corresponds to a first temperature that is higher than a second temperature corresponding to the second temperature characteristic.
